(19) United States
(12) Patent Application Publication
(10) Pub. No.: US 2026/0095860 A1
(43) Pub. Date: Apr. 2, 2026

(54) SUPPORTING BURSTY TRAFFIC VIA LP-WUS

(71) Applicant: InterDigital Patent Holdings, Inc., Wilmington, DE (US)

(72) Inventors: Prasanna Herath, Laval (CA); Young Woo Kwak, Woodbury, NY (US); Moon IL Lee, Melville, NY (US); Samuli Turtinen, Ll (FI); Senay Negusse, Montreal (CA); Nazli Khan Beigi, Longueuil (CA); Virgile Garcia, Antibes (FR)

(73) Assignee: InterDigital Patent Holdings, Inc., Wilmington, DE (US)

(21) Appl. No.: 18/902,071

(22) Filed: Sep. 30, 2024

(51) Int. Cl. H04W 52/02; H04W 72/23; H04W 76/28

(52) U.S. Cl. CPC H04W 52/0235; H04W 72/23; H04W 76/28

(57) ABSTRACT

Devices, systems, and methods to support bursty traffic via low-power wake-up signals for a wireless transmit/receive unit (WTRU). A first LP-WUS is received during a first type LP-WUS MO. The first type LP-WUS includes a first indication and a second indication. A transmission is monitored for, based on the first indication and the second indication. The monitoring includes skipping monitoring for a PDCCH transmission and receiving a second type LP-WUS, based on the first indication having a first value, or monitoring for a PDCCH transmission based on the first indication having a second value. In some implementations, the monitoring comprises monitoring second type LP-WUS MOs sparsely, based on the first indication having the first value and the second indication having the first value, or the monitoring comprises monitoring all second type LP-WUS MOs, based on the first indication having the first value and the second indication having the second value.

### BACKGROUND

Discontinuous reception (DRX) is a type of power saving mechanism where a wireless device attempts to save power by powering down a radio until a scheduled wake time, or based on another event. Wakeup signals (WUS) are another type of power saving mechanism where a wireless device attempts to save power by powering down a main radio until a WUS is received on a low-power WUS radio receiver.

### SUMMARY

Some implementations provide devices, systems, and methods to support bursty traffic via low-power wakeup signals for a wireless transmit/receive unit (WTRU). A first LP-WUS is received during a first type LP-WUS MO. The first type LP-WUS includes a first indication and a second indication. A transmission is monitored for, based on the first indication and the second indication. The monitoring includes skipping monitoring for a PDCCH transmission and receiving a second type LP-WUS, based on the first indication having a first value, or monitoring for a PDCCH transmission based on the first indication having a second value. In some implementations, the monitoring comprises monitoring second type LP-WUS MOs sparsely, based on the first indication having the first value and the second indication having the first value, or the monitoring comprises monitoring all second type LP-WUS MOs, based on the first indication having the first value and the second indication having the second value.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating example receiver architecture for a WTRU that is configured for operation with a LP-WUS;

FIG. 3 is a bar graph illustrating an example of discontinuous reception signaling;

FIG. 4 is a bar graph illustrating example monitoring opportunities and monitoring resources; and

FIG. 5 is a flow chart illustrating an example procedure for configuration of PDCCH monitoring resources and LP-WUS MOs; and

FIG. 6 is a flow chart illustrating another example procedure for configuration of PDCCH monitoring resources and LP-WUS MOs.

### DETAILED DESCRIPTION

Some implementations provide a method implemented in a wireless transmit/receive unit (WTRU). A first type low-power wakeup signal (LP-WUS) is received during a first type LP-WUS monitoring occasion (LP-WUS MO). The first type LP-WUS includes a first indication and a second indication. A transmission is received based on the first indication and the second indication. The receiving includes receiving a second type LP-WUS based on the first indication having a first value. The receiving includes receiving a PDCCH transmission based on the first indication having a second value.

In some implementations, the receiving comprises receiving the second type LP-WUS on one of a plurality of sparsely monitored second type LP-WUS MOs sparsely, based on the first indication having the first value and the second indication having the first value. In some implementations, the receiving comprises receiving the second type LP-WUS one of a plurality of second type LP-WUS MOs, based on the first indication having the first value and the second indication having the second value. In some implementations, the receiving comprises receiving a next PDCCH transmission at an offset, based on the first indication having the second value and the second indication having the first value. In some implementations, the receiving comprises receiving a next PDCCH transmission without an offset, based on the first indication having the second value and the second indication having the second value. Some implementations include receiving configuration information indicating first and second type PDCCH monitoring resources (PDCCH MR). In some implementations, the WTRU receives the first type LP-WUS on a low-power receiver, and receives the PDCCH transmission on a main receiver.

Some implementations provide a method implemented in a WTRU. A first LP-WUS is received during a first type LP-WUS MO. The first type LP-WUS includes a first indication and a second indication. A transmission is monitored for, based on the first indication and the second indication. The monitoring includes skipping monitoring for a PDCCH transmission and receiving a second type LP-WUS, based on the first indication having a first value. The monitoring includes monitoring for a PDCCH transmission, based on the first indication having a second value.

In some implementations, the monitoring comprises monitoring second type LP-WUS MOs sparsely, based on the first indication having the first value and the second indication having the first value. In some implementations, the monitoring comprises monitoring all second type LP-WUS MOs, based on the first indication having the first value and the second indication having the second value. In some implementations, the monitoring comprises monitoring for a next PDCCH transmission at an offset, based on the first indication having the second value and the second indication having the first value. In some implementations, the monitoring comprises monitoring for a next PDCCH transmission without an offset, based on the first indication having the second value and the second indication having the second value. Some implementations include receiving configuration information indicating first and second type PDCCH MRs. In some implementations, the WTRU receives the first type LP-WUS on a low-power receiver, and monitors for the PDCCH transmission on a main receiver.

Some implementations provide a WTRU. The WTRU includes circuitry configured to receive a first type LP-WUS during a first type LP-WUS MO. The first type LP-WUS includes a first indication and a second indication. The WTRU also includes circuitry configured to monitor for a transmission, based on the first indication and the second indication. The monitoring includes skipping monitoring for a PDCCH transmission and receiving a second type LP-WUS based on the first indication having a first value. The monitoring includes monitoring for a PDCCH transmission based on the first indication having a second value.

In some implementations, the monitoring comprises monitoring second type LP-WUS MOs sparsely, based on the first indication having the first value and the second indication having the first value. In some implementations, the monitoring comprises monitoring all second type LP-WUS MOs, based on the first indication having the first value and the second indication having the second value. In some implementations, the monitoring comprises monitoring for a next PDCCH transmission at an offset, based on the first indication having the second value and the second indication having the first value. In some implementations, the monitoring comprises monitoring for a next PDCCH transmission without an offset, based on the first indication having the second value and the second indication having the second value. Some implementations include circuitry configured to receive configuration information indicating first and second type PDCCH MRs.

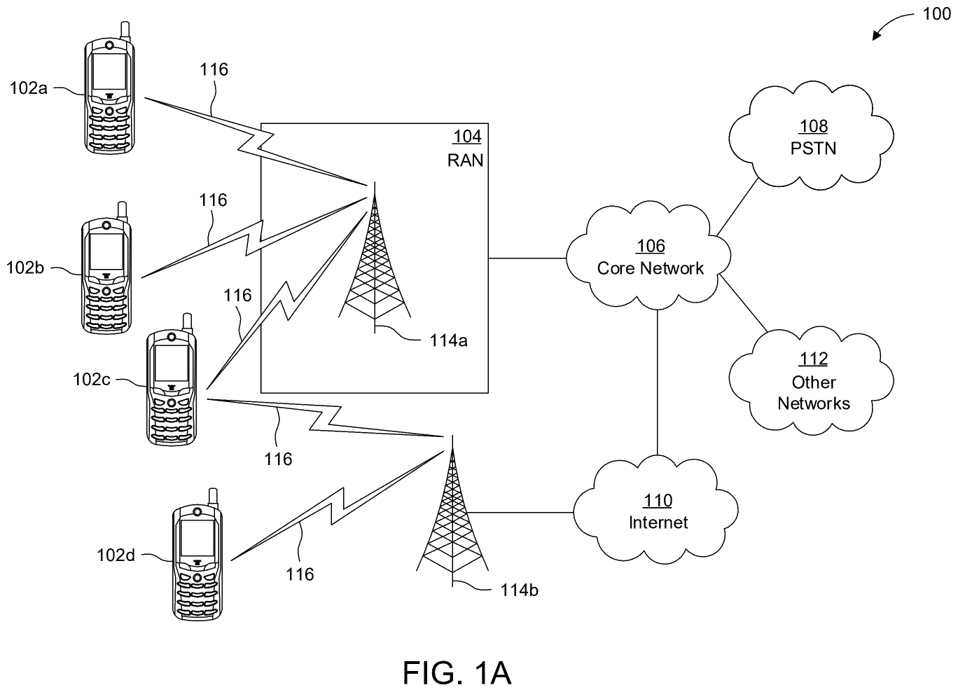

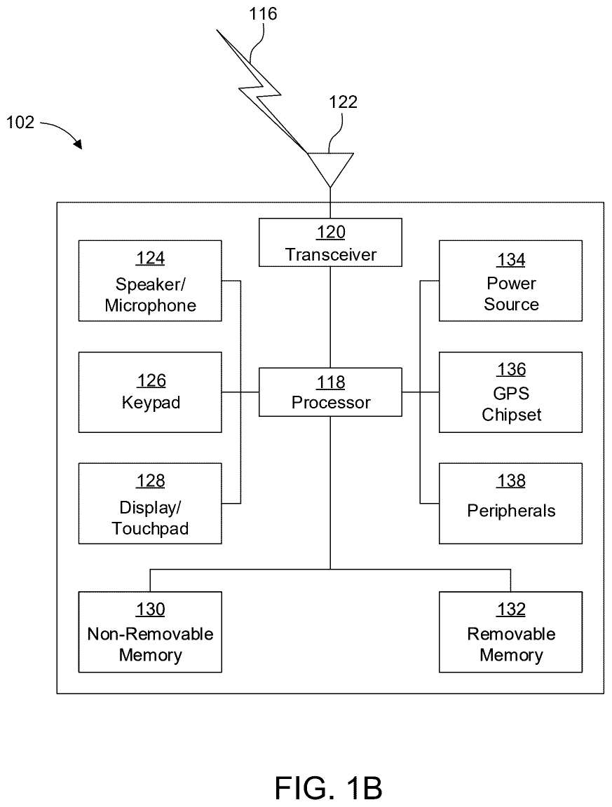

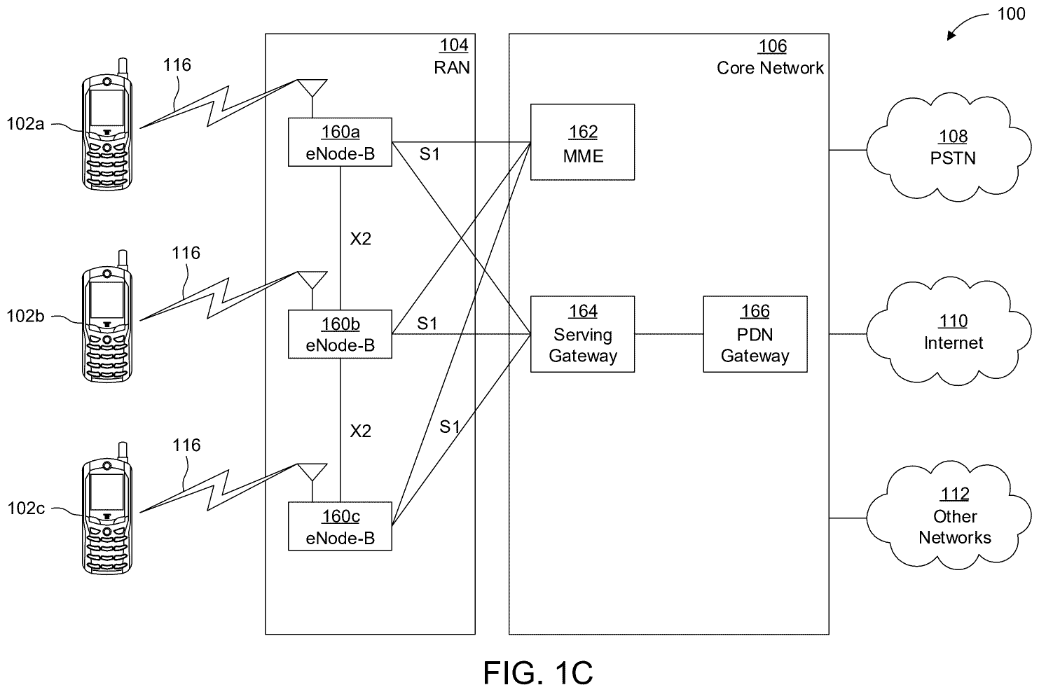

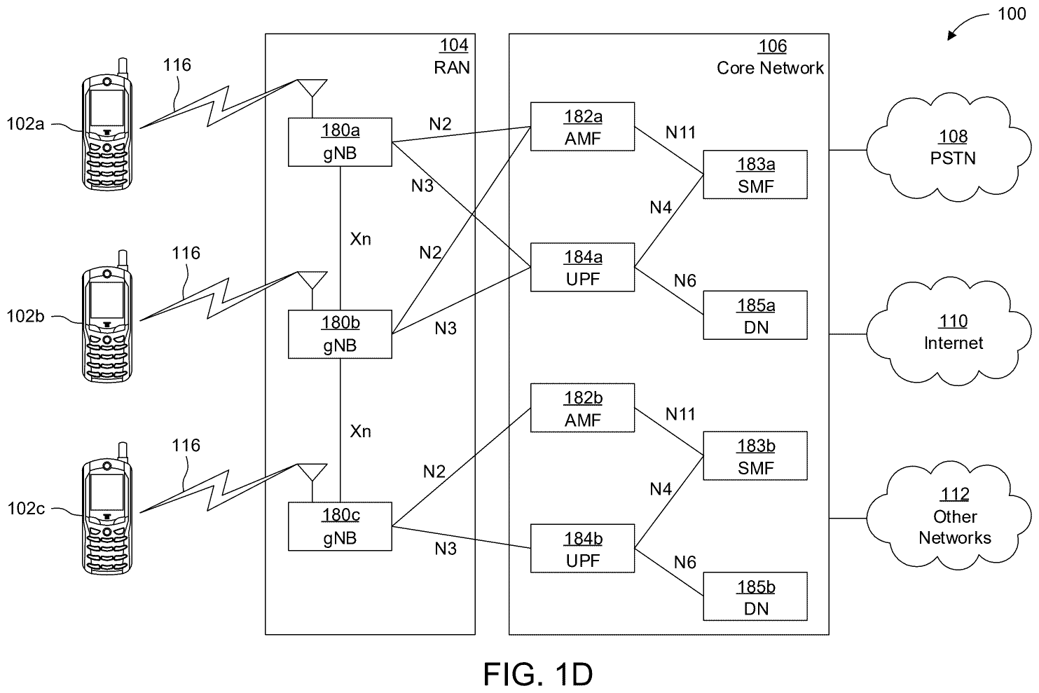

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Some implementations relate to low-power wakeup signal (LP-WUS) monitoring and/or receiving.

For example, in some implementations, a WTRU may monitor for and may receive a wake-up signal (WUS). For example, monitoring for LP-WUS may involve, receiving and/or attempting to receive LP-WUS of one or more preconfigured (e.g., preconfigured via RRC signaling, MAC-CE indication, DCI indication, system information (SI)) formats in one or more preconfigured (e.g., preconfigured via RRC signaling, MAC-CE indication, DCI indication, system information (SI)) resources. Oen or more configuration for formats may include, modulation, payload size, payload structure, and so forth. One or more preconfigured resources may include configuration for starting resources, durations, bandwidth, and so forth. In some implementations, the WUS is received via a first radio. In some implementations, the first radio is a low-power or ultra-low-power radio (e.g., radios that consume less than, or a fraction of power compared to 5G devices that consume tens of milliwatts in RRC idle/inactive state and hundreds of milliwatts in RRC connected state). In some implementations, such WUS may be referred to as a low-power WUS (LP-WUS). In some implementations, the first radio may be referred to as a low-power radio (LR), or a low power wake-up radio (LP-WUR). In some implementations, a received WUS (e.g., an LP-WUS), for example via LR, may trigger the WTRU to “wake-up” or use a second radio of the WTRU. “Wake-up” in this context refers to the WTRU causing the second radio to enter an operational power state (e.g., by powering on the second radio, or by increasing the power of the second radio to an operational level from a “sleep state” or other non-operational power level).

In some implementations, the second radio is configured for data and/or control signal transmission and/or reception. In some implementations, the second radio may be referred to as a “main radio” of the WTRU.

In some implementations, waking the main radio based on a LP-WUS may have the advantage of facilitating reduction in power consumption of wireless devices.

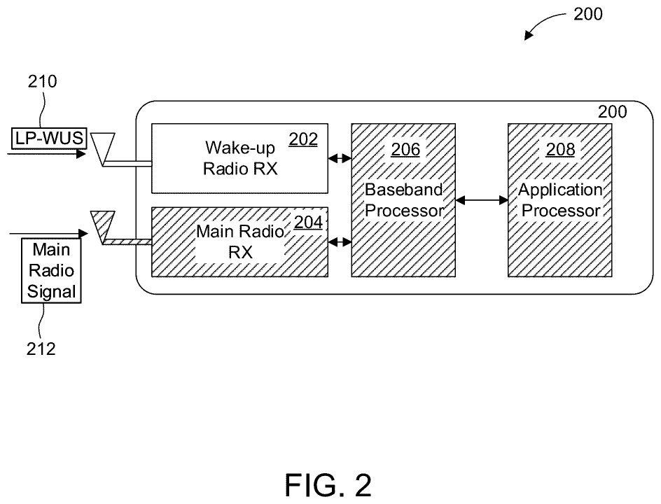

FIG. 2 is a block diagram illustrating example receiver architecture 200 for a WTRU that is configured for operation with a LP-WUS. Receiver architecture 200 includes a wakeup radio receiver 202 and a main radio receiver 204. Wakeup radio receiver 202 and main radio receiver 204 are each in communication with a baseband processor 206, which is in communication with an application processor 208. Wakeup radio 202 is configured to receive a LP-WUS 210, and main radio receiver 204 is configured to receive a main radio signal 212.

Architecture 202 is implementable in any suitable WTRU, such as WTRU 102 as shown and described with respect to FIGS. 1A, 1B, 1C, and 1D. For example, in some implementations, wakeup radio receiver 202 and main radio receiver 204 are implemented as a part of transceiver 120, and baseband processor 206 and application processor 208 are implemented as a part of processor 118.

Some implementations relate to long and short discontinuous reception (DRX).

For example, in some implementations, WTRU traffic or other communications may occur in bursts, or otherwise be bursty in character. In some implementations, this can mean that, for example, immediately after receiving downlink (DL) data, the same WTRU will receive additional further data (e.g., as part of a DL data burst).

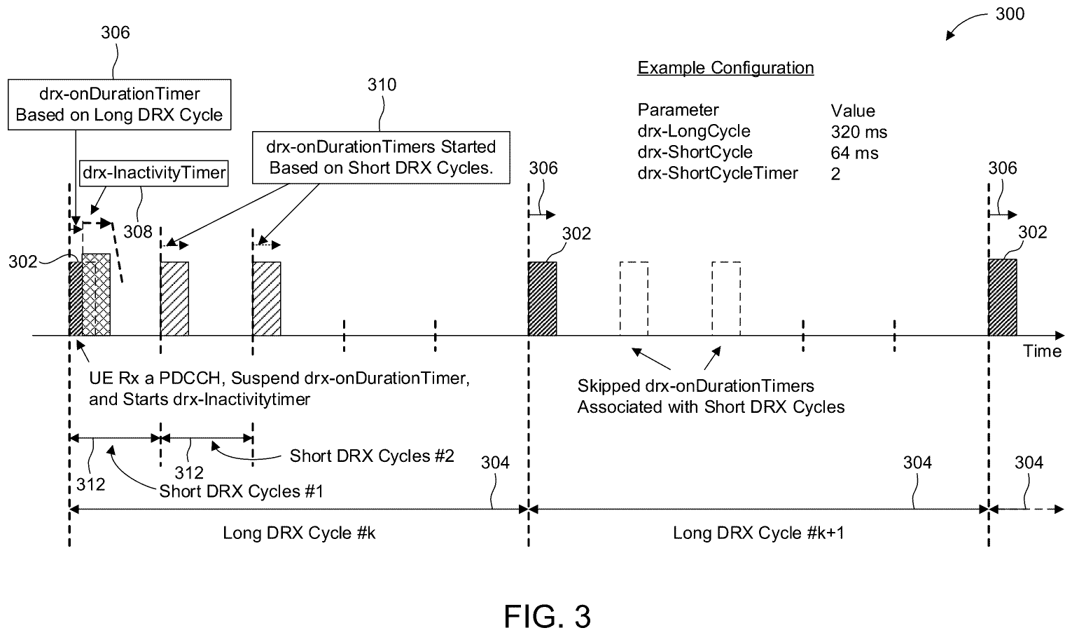

In some implementations, short DRX may be used for DRX operation, e.g., with one or more of the following features: In some implementations, short DRX is only configured with long DRX. In some implementations, short DRX enables additional PDCCH monitoring opportunities if the WTRU receives at least one physical downlink control channel (PDCCH) transmission during DRX ON duration associated with a long DRX cycle (e.g., WTRU receives at least one PDCCH during PDCCH monitoring timer (e.g., drx-onDurationTimer) associated with long DRX cycle. In some implementations, the long DRX cycle is configured to be an integer (n) multiple of the short DRX cycle (e.g., n=5 in the example depicted in FIG. 3, described below). In some implementations, a number of additional DRX on durations used for PDCCH monitoring (e.g., PDCCH monitoring during a time associated with DRX on duration (e.g., drx-onDurationTimers) based on short DRX are configured by RRC parameter drx-ShortCycleTimer. For example, for a period of drx-ShortCycleTimer x short DRX cycle, WTRU may monitor for PDCCHs based on short DRX cycles, immediately after a DRX on duration associated with long DRX. In some implementations, two types of early termination of PDCCH monitoring are supported with long DRX and short DRX. In some implementations, the two types include DRX Command MAC CE, and Long DRX Command MAC CE. For DRX Command MAC CE, after the DRX Command MAC CE is received, the WTRU skips PDCCH monitoring associated with long DRX active time and enters a short drx cycle if configured. For Long DRX Command MAC CE, once the Long DRX Command MAC CE is received, the WTRU stops a drx-ShortCycleTimer that skips reset of the short DRX on durations.

FIG. 3 is a bar graph illustrating an example of discontinuous reception signaling 300 which includes short and long DRX configurations. For example, in signaling 300, a WTRU (referred to as UE in the figure) receives a physical downlink control channel (PDCCH) transmission 302 periodically. The PDCCH transmission 302 is received periodically, with a period defined as a long DRX cycle. Signaling 300 illustrates three PDCCH transmissions 302, each received at the beginning of a long DRX cycle 304, during a drx-onDurationTimer 306 based on long DRX cycle 304. Based on receipt of the PDCCH 302, the WTRU suspends its drx-onDurationTimer based on the Long DRX cycle 304, and starts a drx-InactivityTimer 308 and drx-onDurationTimers 310 that are based on Short DRX Cycles 312.

In the example of FIG. 3, a parameter drx-LongCycle sets the duration of long DRX cycle 304 to 320 milliseconds, and a parameter drx-ShortCycle sets the duration of short DRX cycle 312 to 64 milliseconds. Here, Long DRX cycle 304 is an integer multiple (n) of Short DRX cycle 312 (i.e., n=5 in this example). After receiving a PDCCH during drx-onDurationTimer 302 of long DRX cycle, WTRU starts drx-InactivityTimer for further PDCCH reception. At the end of drx-InactivityTimer, WTRU monitor for PDCCHs during DRX on durations of short DRX cycles for a duration of drx-ShortCycleTimer×short DRX cycle (i.e., 2×short DRX cycle).

Several challenges may arise in the context of DRX. For example, in some implementations, WTRU traffic may be bursty (e.g., may occur in bursts), and traffic arrival times may be unpredictable. For example, in some implementations, immediately after a time when a WTRU is scheduled for data reception, it is likely that the same WTRU will be scheduled for further data reception. Also, in some implementations, the arrival time of traffic for some services (e.g., extended reality (XR)) can be unpredictable.

In some implementations, receiving bursty traffic and traffic with unpredictable arrival may be handled either by implementing short DRX along with long DRX, and/or by supporting a longer inactivity timer. In some implementations however, these alternatives may cause high latency. For example, in cases where no PDCCH is received during a long DRX active time, all short DRX on durations are skipped (i.e., there is no PDCCH monitoring and/or receiving). Further, in some implementations, these alternatives may not able to selectively skip DRX on durations associated with short DRX cycles, and therefore DRX operation may be less flexible and may lead to higher power consumption. Still further, in some implementations, starting points for PDCCH monitoring are semi-statically configured. Therefore, in some implementations, PDCCH monitoring cannot be adjusted to match traffic arrival time.

Accordingly, it may be desired to provide devices, methods, systems, and other approaches to support receiving bursty traffic and/or traffic with unpredictable arrival times in a manner that is power efficient, and/or with low latency.

In some implementations, e.g., to support receiving bursty traffic, a WTRU is configured with first and second types of PDCCH MRs. For example, PDCCH MRs may refer to time-frequency resources, The WTRU may perform PDCCH monitoring via a main radio. In some implementations, the first type of PDCCH MR is periodic, with period T. In some implementations, N (where N≥1) of the second type of PDCCH MRs are located within a time window from each first type PDCCH MR. In some implementations, this may have the advantage of enabling additional opportunities to schedule DL transmission. In some implementations, the time window is of a duration W, where W<T. In some implementations, the WTRU is configured with two types (e.g., first and second types) of LP-WUS monitoring occasions (LP-WUS MOs). For example, each types of LP-WUS MOs may define time-frequency resources for monitoring and receiving LP-WUSs via LR. In some implementations, the first and second type LP-WUS MOs are each located at a offset from first and second PDCCH MRs, respectively. The offsets for the first and second type LP-WUS MOs may be of different lengths of time and/or frequency.

In an example, in some implementations, based on indications received in first type LP-WUS, a WTRU determines whether to monitor for PDCCH transmissions in a first type PDCCH MR, determines a configuration for PDCCH monitoring in first type PDCCH MR, and/or determines a configuration for monitoring second type LP-WUS MOs. In an example, implementation, configuration for monitoring PDCCHs in 1^{st} type PDCCH MR may include, beginning to monitor for PDCCHs in the next occurrence of a first type PDCCH MR with an offset or without any offset. In an example implementation, configuration for monitoring second type LP-WUS MOs may include only monitoring a subset of the second type LP-WUS MOs (e.g., every other second type LP-WUS MO) or monitoring all configured second type LP-WUS MOs.

In some implementations, based on indications received in first and second type LP-WUSs collectively (e.g., based on indications received in both first type LP-WUS and second type LP-WUS), the WTRU determines whether to monitor for PDCCH transmissions in second type PDCCH MRs.

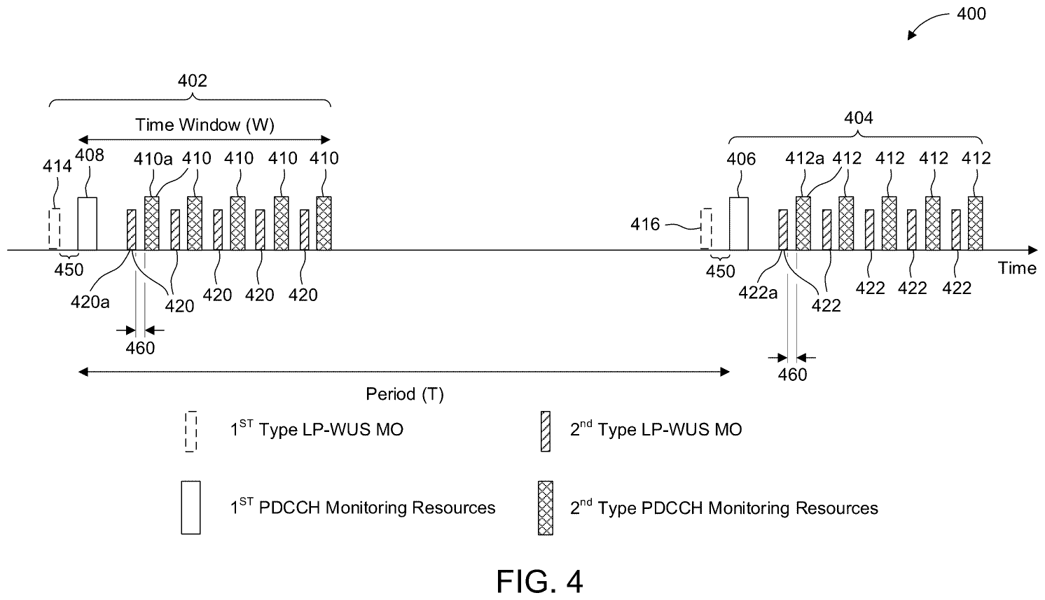

FIG. 4 is a bar graph 400 illustrating example monitoring opportunities and monitoring resources. Bar graph 400 illustrates a first set 402 of LP-WUS MOs and PDCCH MRs, and a second set 404 of LP-WUS MOs and PDCCH MRs.

First type PDCCH MRs occur periodically with period T. For example, first type PDCCH MR 406 of second set 404 occurs T time after first type PDCCH MR 408 of first set 402 in this example. Within a period T, second type PDCCH MRs occur within time window W of first type PDCCH MRs. For example, second type PDCCH MRs 410 occur within time window W (which may be preconfigured, e.g., via RRC signaling, MAC-CE indication, DCI indication) after PDCCH MR 408, and second type PDCCH MRs 412 occur within time window W after PDCCH MR 406. In an example implementation, a first second type PDCCH MR out of all second type PDCCH MRs may located a preconfigured (e.g., preconfigured via RRC signaling, MAC-CE indication, DCI indication) offset from first type PDCCH MR. The starting points of remaining (N−1) second type PDCCH MRs may be equally spaced in time withing the remaining time of the time window W.

First type LP-WUS MOs occur at a first offset time from first type PDCCH MRs. For example, first type LP-WUS MO 414 occurs at a first offset time 450 before first type PDCCH MR 408, and first type LP-WUS MO 416 occurs at a first offset time 450 before first type PDCCH MR 406. First type LP-WUS MOs are periodic with period T.

Second type LP-WUS MOs occur at a second offset time from second type PDCCH MRs. For example, second type LP-WUS MO 420a occurs at a second offset time 460 before second type PDCCH MR 408, and second type LP-WUS MO 422a occurs at a second offset time 460 before second type PDCCH MR 406. In some implementations, second type LP-WUS MOs 420 and 422 are periodic within time window W.

Some implementations include LP-WUS, LP-WUS MO, PDDCH, and/or PDDCH MR configurations, e.g., to support reception of bursty traffic.

For example, in some implementations, a WTRU may receive one or more configurations. In some implementations, the WTRU is capable of monitoring LP-WUS, and the configurations support reception of bursty traffic. In some implementations, the WTRU receives the one or more configurations from a gNB, base station, or other network device.

In some implementations, the WTRU receives the one or more configurations via radio resource control (RRC) signaling, via a medium access control control element (MAC-CE) indication, via a downlink control information (DCI) indication, via a system information (SI), or in another suitable manner.

One example configuration which may be received by the WTRU indicates two types of PDCCH monitoring resources (MRs). For example, in some implementations, the WTRU may receive a configuration indicating first and a second type PDCCH MRs. In some implementations, a first type PDCCH MR is periodic, with periodicity T. In some implementations, each PDCCH MR may include a set of time-frequency resources in which the WTRU may monitor for and/or may receive PDCCH transmissions. In some implementations, a set of N (where N≥1) second type PDCCH MRs may be associated with each first type PDCCH MR. In some implementations, a set of N second type PDCCH MRs associated with a first type PDCCH MR may be located within a time window (W) from the first type PDCCH MR. In some implementations, W<T (e.g., as illustrated with respect to FIG. 4).

Another example configuration which may be received by the WTRU indicates two types of LP-WUS MOs. For example, in some implementations, each first type LP-WUS MO is associated with a first type PDCCH MR. In some implementations, the first type LP-WUS MO is located at a first offset before a starting point of the associated first type PDCCH MRs. In some implementations, each second type LP-WUS MO is associated with a second type PDCCH MR. In some implementations, the second type LP-WUS MO is located a second offset prior to the starting point of a set of associated second type PDCCH MRs (e.g., as illustrated with respect to FIG. 4.)

Another example configuration which may be received by the WTRU indicates an identity (ID) of the WTRU, or subgroup ID which indicates a subgroup that includes the WTRU. In some implementations, the ID may be included in or indicated by first and/or second type LP-WUSs. In some implementations, the ID included in or indicated by the first and/or second type LP-WUSs may be used by the WTRU to determine that the first and/or second type LP-WUS is intended for the WTRU. In some implementations, the WTRU wakes up based on the ID included in or indicated by the first and/or second type LP-WUS. In some implementations, the WTRU may receive a second ID to be used as local ID or the WTRU may determine a local ID based on 5G-TMSI or 5G-S-TMSI. In some implementations, the WTRU may receive a subgroup ID or the WTRU may determine a subgroup ID based on a configured WTRU ID (e.g., a local UE ID).

Another example configuration which may be received by the WTRU indicates how many WTRUs are associated with first and second type LP-WUS and/or how many subgroups are associated with first and second type LP-WUS.

Another example configuration which may be received by the WTRU indicates a structure of first type LP-WUSs and/or second type LP-WUSs.

In an example structure, a first type LP-WUS may include two fields (e.g., first field, and second field) for each WTRU associated with it. In some implementations, each field may be 1 bit in length. In some implementations, a payload of the first type LP-WUS may be structured based on local WTRU ID or subgroup ID. For example, in some implementations, first and second bits (for example) in first type LP-WUS may act as first and second fields corresponding to a first WTRU (e.g., with a local WTRU ID=0). In the same example, third and fourth bits (for example) in the first type LP-WUS may act as first and second fields corresponding to a second WTRU (e.g., with a local WTRU ID=1), and so forth. It is noted that this is only an example, and that other implementations of first type LP-WUS may include any number of fields for each WTRU associated with it, and the fields may include any number of bits, and any particular bits.

In another example structure, a second type LP-WUS may include a 1-bit indication for each WTRU, or each subgroup of WTRUs associated with a corresponding first type LP-WUS. In some implementations, a payload in the second type LP-WUS may be ordered based on a local WTRU ID or subgroup ID. It is noted that this is only an example, and that different types of second type LP-WUS may include any number of fields for each WTRU associated with it, and the fields may include any number of bits, and any particular bits.

Another example configuration which may be received by the WTRU indicates an offset. In some implementations, the offset is a PDCCH-monitoring-offset, associated with PDCCH monitoring in first PDCCH monitoring resources. In some implementations, the PDCCH-monitoring-offset may be configured in units of time (e.g., milliseconds), symbols, etc.

Another example configuration which may be received by the WTRU indicates two or more configurations for monitoring a second type LP-WUS. In some implementations, this includes a first and second configuration for monitoring a second type LP-WUS.

For example, in some implementations, the first and second configurations may be associated with sparse monitoring and monitoring all second type LP-WUS MOs, respectively, to change or scale monitoring periodicity associated with second type LP-WUSs. In other words, the first configuration indicates that the WTRU should only monitor a subset of the second type LP-WUS MOs (e.g., every other second type LP-WUS MO, or every third second type LP-WUS MO, etc.) and the second configuration indicates that the WTRU should monitor all LP-WUS MOs.

In another example, in some implementations, the first and second configurations may associated with skipping (e.g., with the WTRU not monitoring for 2^{nd} type LP-WUSs in skipped 2^{nd} type LP-WUS MOs) the first K (<N) second type LP-WUS MOs and with monitoring second type LP-WUSs in all configured second type LP-WUS MO, respectively. In other words, the first configuration indicates that the WTRU should only monitor second type LP-WUS MOs after the first K second type LP-WUS MOs (i.e., should skip the first K second type LP-WUS MOs), and the second configuration indicates that the WTRU should monitor all second type LP-WUS MOs.

In another example, in some implementations, the first and second configurations may be associated with skipping the last K (<N) second type LP-WUS MOs in a set, and monitoring second type LP-WUSs in all configured second type LP-WUS MO, respectively. In other words, the first configuration indicates that the WTRU should only monitor second type LP-WUS MOs before the last K second type LP-WUS MOs (i.e., should skip the first K second type LP-WUS MOs), and the second configuration indicates that the WTRU should monitor all second type LP-WUS MOs.

Another example configuration which may be received by the WTRU indicates a threshold duration over which the WTRU will monitor for second type LP-WUSs without receiving a wake-up indication, such as an indication to monitor for PDCCH transmissions in next occurrence of second type PDCCH MR. In other words, the configuration may indicate how long a WTRU will continue monitoring for second type LP-WUSs in second type LP-WUS MOs without receiving a wake-up indication in a second LP-WUS. In some implementations, e.g., in cases where the WTRU does not receive a wake-up indication withing the threshold duration, the WTRU may skip monitoring for 2^{nd} type LP-WUS in the remaining 2^{nd} type LP-WUS MOs. In some implementations, the threshold duration may be configured in units of a number of second type LP-WUS MOs (e.g., as a threshold number of second type LP-WUS MOs), a number of slots, a number frames, a number of symbols, in units of time (e.g., milliseconds), or any other suitable unit.

Another example configuration which may be received by the WTRU sets a parameter (e.g., “monitor-secondLPWUS”) to enable WTRU monitoring for second type LP-WUSs if the WTRU does not receive any PDCCH transmissions during a first type PDCCH MR.

Another example configuration which may be received by the WTRU indicates that the WTRU should activate LP-WUS monitoring via LR. For example, in some implementations, the WTRU may receive an indication (e.g., via MAC-CE indication, DCI indication, SI, RRC release message, etc.) to begin monitoring for LP-WUS. Based on the indication, or based on receipt of the indication (e.g., upon indication), the WTRU may begin monitoring for LP-WUS. Alternatively, in some implementations, the WTRU may begin monitoring for LP-WUS after the WTRU receives one or more configurations (e.g., receives an indication configuring an LP-WUS MO, signal structure etc.).

For example, in some implementations, a WTRU may begin monitoring LP-WUS at a first, first type LP-WUS MO (e.g., starting from the first symbol of LP-WUS MO) located at least an offset after the time WTRU receives the indication or configuration for monitoring LP-WUS. In some implementations, the offset is preconfigured (e.g., via RRC signaling, MAC-CE indication, DCI indication, etc.)

In another example, in some implementations, a WTRU may start a timer (or begin tracking the corresponding time in some other manner) based on receiving an indication and/or configuration for monitoring LP-WUS. In some implementations, the WTRU may begin monitoring for LP-WUS from the first, first type LP-WUS MO (e.g., from the first symbol of the first type LP-WUS MO) after the timer expires. In some implementations, the timer is preconfigured (e.g., via MAC-CE indication, DCI indication, SI, RRC release message, etc.)

In some implementations, one, some, or all of these or other configurations may be received together as part of a single configuration, or separately as part of several different configurations.

Some implementations include first and second LP-WUSs, e.g., to support bursty traffic.

For example, in some implementations, a WTRU may monitor LP-WUS. In some implementations, the WTRU may monitor first-type LP-WUS and second-type LP-WUS. In some implementations, the WTRU may monitor first-type LP-WUS in first type LP-WUS MOs and second-type LP-WUS in second type LP-WUS MOs. In some implementations, the WTRU may also monitor first type PDCCH MRs and second type PDCCH MRs. In some implementations, a WTRU may include and/or operate according to one or more of the following example implementations.

In some implementations, a WTRU may determine whether to monitor for PDCCHs in first type PDCCH MR based on indications received in first type LP-WUS, and/or may be configured for monitoring PDCCHs in first type PDCCH MRs based on indications received in first type LP-WUS. For example, in some implementations, a WTRU may determine whether to start monitoring PDCCHs with a delay.

For example, in some implementations, a first configuration (e.g., “Example Configuration-A”), a first type LP-WUS may include 2-fields (e.g., x, y) for each WTRU, or for each subgroup of WTRUs, associated with the first LP-WUS. In some implementations, each of the two fields may be 1-bit in length. In some implementations, the WTRU may identify which 2-bits in the first type LP-WUS carry an indication for itself based on a local WTRU ID or subgroup ID. For example, in some implementations, first and second bits (for example) in first type LP-WUS may act as x and y bits corresponding to a first WTRU (e.g., with a local WTRU ID=0). In the same example, third and fourth bits (for example) in the first type LP-WUS may act as x and y bits corresponding to a second WTRU (e.g., with a local WTRU ID=1), and so forth. It is noted that this is only an example, and that other implementations of first type LP-WUS may include any number of fields for each WTRU associated with it, and the fields may include any number of bits, and any particular bits.

In some implementations, the x-bit may indicate either (a) a configuration associated with monitoring PDCCHs in the next occurrence of a first type PDCCH MR or (b) a configuration associated with second type LP-WUS monitoring in the next N occurrences of second type LP-WUS MOs. In some implementations, the y-bit may indicate whether the x-bit is associated with (a) or (b). For example, y=0 for (a), and y=1 for (b). It is noted that the names “x” and “y” for these bits or fields is only an example, and that such bits or fields may be referred to in any suitable manner.

In some implementations of “Example Configuration-A”, if the WTRU receives a first value (e.g., y=0) for y, the WTRU may monitor for and/or receive PDCCH transmissions in next occurrence of first type PDCCH MR. In some implementations, the WTRU may determine a configuration for monitoring PDCCHs in next occurrence of first type PDCCH MR based on indications received in x.

In an example, if the WTRU receives first value for x (e.g., x=1), the WTRU may begin monitoring with an offset (e.g., with a duration indicated by a parameter, such as “PDCCH-monitoring-offset”). In some implementations, the WTRU may start a timer associated with PDCCH monitoring. In some implementations, the WTRU monitors for PDCCH transmissions while the timer is running. In some implementations, the WTRU may begin monitoring for PDCCH transmissions after a delay (e.g., of a duration indicated by PDCCH-monitoring-offset). In another example, the WTRU may start a timer associated with PDCCH monitoring with a delay (e.g., of a duration indicated by PDCCH-monitoring-offset). In some implementations, the delay is from a configured starting point of the PDCCH monitoring. In some implementations, the starting point is semi-statically configured (e.g., via RRC signaling). In some implementations, if the WTRU receives a second value (e.g., x=0) for x, the WTRU may begin monitoring for PDCCHs in the next occurrence of a first type PDCCH MR without any offset.

In another example, if the WTRU receives a first value for x (e.g., x=1), the WTRU may monitor for PDCCHs in a first preconfigured SS set within next occurrence of first type PDCCH MRs. In some implementations, the SS set is preconfigured via RRC signaling, MAC-CE indication, DCI indication. In some implementations, if the WTRU receives a second value for x (e.g., x=0), the WTRU may monitor for PDCCHs in a second SS set within the next occurrence of first type PDCCH MRs.

In some implementations, if the WTRU receives a second value for y (e.g., y=1), the WTRU may skip monitoring for PDCCH transmissions in the next occurrence of first type PDCCH MRs.

In another example implementation, based on indications received in first type LP-WUS, a WTRU may determine a configuration for monitoring second type LP-WUS in the next N occurrences of second type LP-WUS MOs after the skipped monitoring for PDCCH transmissions in first type PDCCH MRs. For example, in some implementations, if the WTRU receives a second value (i.e., y=1) for y, (i.e., when UE skips monitoring for PDCCHs in the next occurrence of first type PDCCH MR) the WTRU may monitor for second type LP-WUSs in the next N occurrences of second type LP-WUS MOs and may determine a configuration for monitoring second type LP-WUS based on x.

For example, in some implementations, if the WTRU receives a first value for x (e.g., x=0), the WTRU may monitor for second type LP-WUSs in next N occurrences of second type LP-WUS MOs sparsely. For example, monitoring sparsely, the WTRU may skip one second type LP-WUS MO after each monitored second type LP-WUS MO—i.e., may monitor every-other second type LP-WUS MO. In some implementations, if the WTRU receives a second value (e.g., x=1) for x, UE may monitor for second type LP-WUSs in all next N occurrences of second type LP-WUS MOs (i.e., sparse monitoring is disabled). It is noted that sparse monitoring may include any suitable sparsity of monitoring (e.g., every other, every three, every four, two out of four, three out of four, etc.) In another example, in some implementations, if the WTRU receives first value for x (e.g., x=0), the WTRU may skip the first K (where K<N) occurrences of N second type LP-WUS MOs and may monitor for second type LP-WUSs in the remaining (N−K) occurrences of second type LP-WUS MOs. In some implementations, if the WTRU receives the second value for x (e.g., x=1), the WTRU may monitor for second type LP-WUSs in the N next occurrences of second type LP-WUS MOs.

In another example, in some implementations, if the WTRU receives the first value for x (e.g., x=0), the WTRU may skip the last K (where K<N) occurrences of second type LP-WUS MOs and may monitor for and/or receive second type LP-WUSs in first (N−K) occurrences of second type LP-WUS MOs. In some implementations, if the WTRU receives the second value for x (e.g., x=1), the WTRU may monitor for and/or receive second type LP-WUSs in N next occurrences of second type LP-WUS MOs.

In another example implementation, based on indication received in second type LP-WUS, the WTRU may selectively monitor for PDCCHs in second type PDCCH MRs.

For example, in some implementations, if the WTRU determines to monitor for PDCCHs in second type PDCCH MRs (e.g., based on an indication received in a first type LP-WUS), the WTRU may monitor for second type LP-WUSs in second type LP-WUS MOs associated with each second type PDCCH MR. For example, in some implementations, a second type LP-WUS may include an indication (e.g., a 1 bit indication) for each WTRU or subgroup associated with first type LP-WUS. In some implementations, each indication (e.g., 1-bit indication), for each WTRU or each subgroup, that is included in the second type LP-WUS may be ordered based on local WTRU ID or subgroup ID. In some implementations, if the WTRU receives a first indication (e.g., a 1 bit indication having a first value (e.g., 1)), the WTRU may monitor for PDCCHs in the next occurrence (i.e., occurrence of a second type PDCCH MR associated with the second type LP-WUS MO in which the second type LP-WUS is received) of second type PDCCH MRs. In some implementations, if the WTRU receives a second indication (e.g., 1-bit indication having a second value (e.g., 0)), the WTRU may skip monitoring PDCCHs in the next occurrence of second type PDCCH MRs.

In another example implementation, based on not receiving any indication in one or more (e.g., L (<N)) consecutive second type LP-WUS MOs indicating to monitor for PDCCHs in associated second type PDCCH MR, the WTRU may skip monitoring for second type LP-WUSs in the remaining (=N−L) occurrences of second type LP-WUS MOs and may skip monitoring PDCCH in the remaining (=N−L) occurrences of second type PDCCH MRs.

For example, in some implementations of the “Example Configuration-A”, the WTRU may monitor for second type LP-WUSs in second type LP-WUS MOs if the WTRU receives the second value for y (e.g., y=1). In some implementations, if the WTRU does not receive an indication to monitor for PDCCHs in a second type PDCCH MR in consecutive M (where M<N) second type LP-WUSs received in second type LP-WUS MOs, the WTRU may skip monitoring for second type LP-WUS in the remaining (=N−M) occurrences of second type LP-WUS MOs. In some implementations, the WTRU may skip monitoring for PDCCH transmissions in second type PDCCH MRs associated with skipped second type LP-WUS MOs. In some implementations, a WTRU that skips monitoring the remaining (=N−M) occurrences of second type LP-WUS MOs may monitor for first type LP-WUSs in the next occurrence of first type LP-WUS MOs.

In another example implementation, based on not receiving any PDCCH transmissions in one or more (e.g., P, e.g., P≤L) consecutive second type PDCCHs MRs, a WTRU may skip monitoring for second type LP-WUSs in remaining occurrences of one or more second type LP-WUS MOs and/or one or more PDCCH monitoring in remaining (N−P) occurrences of second type PDCCH MR. For example, in some implementations, the WTRU may skip monitoring all remaining occurrences of second type LP-WUS MOs until the next occurrence of first type LP-WUS MO, and/or may skip monitoring all remaining occurrences of second type PDCCH MR until the next occurrence of first PDCCH MR.

For example, in some implementations of “Example Configuration-A”, if the WTRU receives a first value for y (e.g., y=0), the WTRU may monitor for and/or receive PDCCH transmissions in the next occurrence of first type PDCCH MR. In some implementations, if the WTRU receives at least one PDCCH transmission in first type PDCCH MRs that it is monitoring, the WTRU may begin monitoring for and/or receiving PDCCH transmissions in the next N occurrences of second type PDCCH MR. In some implementations, if the WTRU does not receive any PDCCHs in a number P of consecutive occurrences of second type PDCCH MR, the WTRU may skip monitoring the remaining (=N−P) occurrences of second type PDCCH MR. In some implementations, such WTRU that skipped monitoring the remaining (=N−P) second type PDCCH MRs may monitor for first type LP-WUSs in the next occurrence of first type LP-WUS MO.

In another example implementation, based on an indication received via a PDCCH transmission received in a second type PDCCH MR, the WTRU may skip monitoring for PDCCH transmissions in remaining second type PDCCH MRs. In some implementations, based on an indication received via a PDCCH transmission received in a second type PDCCH MR, the WTRU may skip monitoring for PDCCH transmissions in remaining second type PDCCH MRs until the next occurrence of first type PDCCH MR and/or may skip LP-WUS monitoring in remaining LP-WUS MOs until the next occurrence of first type LP-WUS MOs. In some implementations, the indication received via a PDCCH transmission comprises an indication received in a PDCCH transmission or an indication received in a MAC-CE or PDCCH scheduled by a PDCCH transmission received in a second type PDCCH MR.

For example, in some implementations of “Example Configuration-A”, if the WTRU receives a first value for y (e.g., y=0), the WTRU may monitor for and/or receive PDCCH transmissions in the next occurrence of first type PDCCH MRs. In some implementations, if the WTRU receives at least one PDCCH in a first type PDCCH MR being monitored by the WTRU, the WTRU may begin monitoring for and/or receiving PDCCH transmissions in the next N occurrences of second type PDCCH MR. In some implementations, if the WTRU does not receive any PDCCHs in P consecutive occurrences of second type PDCCH MR, the WTRU may skip monitoring the remaining (N−P) occurrences of second type PDCCH MR. In some implementations the WTRU, which skipped monitoring the remaining (=N−P) second type PDCCH MRs, may monitor for first type LP-WUSs in the next occurrence of first type LP-WUS MOs.

In another example implementation, based on an indication received via a PDCCH transmission received in first type PDCCH MR, the WTRU may skip monitoring for PDCCH transmissions in remaining resources of the first type PDCCH MR and/or may skip monitoring for LP-WUS in the next N occurrences of second type LP-WUS MOs. In other words, the WTRU may skip monitoring for PDCCH transmissions at least until the next occurrence of a second type LP-WUS MO and/or may skip monitoring for PDCCH transmissions in next N occurrences of second type PDCCH MR until next occurrence of a first type PDCCH MR. In some implementations, the indication received via a PDCCH transmission comprises an indication received in a PDCCH transmission or an indication received in a MAC-CE or PDCCH scheduled by a PDCCH transmission received in a first type PDCCH MR.

For example, in some implementations of “Example Configuration-A”, if the WTRU receives a first value for y (e.g., y=0), the WTRU may monitor for and/or receive PDCCH transmissions in the next occurrence of first type PDCCH MRs. In some implementations, if the WTRU receives an indication in a received PDCCH transmission or signal and/or channel scheduled by a PDCCH transmission received in this MR, the WTRU may skip monitoring PDCCHs in remaining resources of this first type PDCCH MR and/or may skip monitoring for LP-WUS in the next N occurrences of second type LP-WUS MOs. In some implementations, if the WTRU receives an indication in a received PDCCH transmission or signal and/or channel scheduled by a received PDCCH transmission, the WTRU may skip monitoring PDCCHs in remaining resources of the first type PDCCH MR and/or may skip monitoring for LP-WUS in the next N occurrences of second type LP-WUS MOs until the next occurrence of a first type LP-WUS MO and/or may skip monitoring for PDCCH transmissions in the next N occurrences of second type PDCCH MRs, i.e., at least until next occurrence of a first type PDCCH MR.

Some implementations include second type LP-WUS monitoring that is triggered by data activity.

In some implementations, a WTRU may be configured to receive a primary or default LP-WUS (e.g., first type LP-WUS) which indicates to the WTRU to monitor for PDCCH MR(e.g., first type PDCCH MR). In some implementations, if the WTRU receives a PDCCH transmission while monitoring for the first type PDCCH MR, the WTRU determines whether the PDCCH transmission is addressed to a WTRU ID (e.g., based on a C-RNTI configured by the network). In some implementations, based on the receival of the PDCCH transmission, the WTRU determines to monitor for second type LP-WUS and/or the WTRU determines a configuration to monitor for second type LP-WUS.

For example, in some implementations, the WTRU first monitors for first type LP-WUS on 1^{st} type LP-WUS MO with periodicity P1 using a first radio (e.g., LR). If the WTRU receives a first type LP-WUS that indicates that the WTRU should monitor for PDCCH (e.g., on first type of PDCCH MR), the WTRU monitors for PDCCH transmissions with a second radio (e.g., main radio). In some implementations, the different radios used to monitor for and receive LP-WUS, and to monitor for and receive PDCCH transmissions, are not explicitly specified but are left as implementation details. In some implementations, the WTRU, monitoring for PDCCH transmissions, may receive a PDCCH transmission addressed to a WTRU ID (e.g., based on a C-RNTI configured by the network) which may indicate a DL or UL transmission or retransmission over a physical downlink shared channel (PDSCH) or physical uplink shared channel (PUSCH), respectively (or 6G or other equivalents). In some implementations, based on the received PDCCH transmission, the WTRU determines to monitor for second type LP-WUS and/or the WTRU determines a configuration for monitoring for second type LP-WUS.

In another example, in some implementations, if the WTRU determines to monitor for second type LP-WUS, it monitors during LP-WUS MOs configured for the second type of LP-WUS with periodicity P2. In some implementations, the first and second type LP-WUS signal may be the same or different and the WTRU may be indicated by the same or different WTRU ID, WTRU subgroup ID, or other suitable identifier, by both types of LP-WUS. In this example, the periodicity of first and second type LP-WUS MOs is different (i.e., the periodicity P2 is shorter or longer than periodicity P1). In some implementations, periodicity P1 is a multiple of periodicity P2. In some implementations, the WTRU may determine to monitor for second type LP-WUS for a number of monitoring occasions after determining to monitor for second type LP-WUS based on the PDCCH transmission over first type PDCCH MR. In some implementations, the WTRU monitors for second type LP-WUS for N number of LP-WUS MOs, where N may be a configurable parameter (it is noted that N may also be equal to 1). For example, in some implementations, monitoring for second type LP-WUS is started after the PDCCH monitoring on first type PDCCH MR is stopped (e.g., by an expiry of a timer).

In another example, in some implementations, if the WTRU monitors for second type LP-WUS and receives an LP-WUS indication to trigger monitoring for PDCCH transmissions, the WTRU monitors for PDCCH transmissions in second type PDCCH MR. In some implementations, first and second type PDCCH MR may use the same or different resource configurations, and/or may have the same or different configurations generally. In some implementations, the WTRU may determine to monitor for second type LP-WUS for number of second type LP-WUS MO after determining to monitor for second type LP-WUS based on the PDCCH transmissions over the second type PDCCH MR. For example, in some implementations the WTRU monitors for second type LP-WUS for M number of 2^{nd} type LP-WUS MOs, where M may be a configurable parameter (it is noted that M may also be equal to 1). For example, in some implementations, monitoring for second type LP-WUS is started after the PDCCH monitoring on second type of PDCCH MR is stopped (e.g., by an expiry of a timer). In some implementations, M may be equal to the value N discussed above, or may be configured differently. For example, in some implementations, a PDCCH transmission received on a second type PDCCH MR will prolong the monitoring time for second type LP-WUS. In another example, in some implementations, the WTRU determines to monitor second type LP-WUS only based on a PDCCH transmission received on first type of PDCCH MR. In some implementations, alternatively, or additionally, based on the PDCCH transmission over the second type PDCCH MR indicating a new transmission over DL or UL, the WTRU determines the value of M. In some implementations, based on the PDCCH transmission over the second type PDCCH MR indicating a re-transmission over DL or UL, the WTRU does not determine the value of M (i.e., the WTRU does not prolong the monitoring for second type LP-WUS.)

In some implementations, a WTRU may be configured to receive a primary or default LP-WUS (e.g., first type LP-WUS) which indicates to the WTRU to monitor for PDCCH transmissions on PDCCH MR (e.g., first type PDCCH MR). In some implementations, based on receiving a PDCCH transmission, the WTRU determines whether it received specific DL data or whether it transmitted specific UL data. In some implementations, based on this determination, the WTRU determines to monitor for second type LP-WUS and/or WTRU determines a configuration for monitoring for second type of LP-WUS.

For example, in some implementations, the WTRU first monitors first type LP-WUS on first type LP-WUS MO with periodicity P1 using a first radio (e.g., LR). In some implementations, if the first type LP-WUS indicates to the WTRU to monitor for PDCCH transmissions (on first type of PDCCH MR), the WTRU monitors the PDCCH with its main radio (MR). In some implementations, the different radios used to monitor for and receive LP-WUS, and to monitor for and receive PDCCH transmissions, are not explicitly specified but are left as implementation details. In some implementations, the WTRU, monitoring for PDCCH transmissions, may receive a PDCCH transmission addressed to a WTRU ID (e.g., which is indicated based on a C-RNTI configured by the network) which can indicate a DL or UL transmission or retransmission over PDSCH or PUSCH, respectively (or 6G or other equivalents). In some implementations, alternatively, or additionally, the WTRU may receive a PDSCH transmission over semi-persistent scheduling (SPS) resources or may transmit a PUSCH transmission over configured grant (CG) resources. In some implementations, based on the DL transmission or transmissions received or the UL transmission or transmissions configured or scheduled, the WTRU determines the type of data included in the MAC PDU of the DL transmission or the UL transmission, respectively. In some implementations, based on the type of data included in a MAC PDU being a specific type of data, the WTRU determines to monitor for second type LP-WUS and/or the WTRU determines a configuration for monitoring for second type of LP-WUSs in second type LP-WUS MOs. In some implementations, the type of data included in the MAC PDU of the received DL transmissions and/or the UL transmission or transmissions configured or scheduled is used to determine whether to monitor for second type LP-WUS.

In another example, in some implementations, the specific type of data may be determined based on the data received and/or transmitted through one or more specific logical channels, one or more specific data and/or signaling radio bearers (DRB/SRB), one or more specific QoS flows, one or more specific PDU sessions, one or more specific PDU sets, or any other suitable basis. In another example, the specific type of data may be or include one or more specific or specific types of MAC CEs. For example, in some implementations, for DL, the specific or specific type MAC CEs may be or include one or more MAC CEs for activation and/or deactivation of semi-persistent channel state information (CSI) reporting on a physical uplink control channel (PUCCH), for activation and/or deactivation of a semi-persistent sounding reference signal (SRS) and indication of spatial relation of SP/AP SRS, or any other suitable MAC CEs. In some implementations, for UL, the specific or specific type MAC CEs may be or include one or more Buffer Status Report MAC CEs, one or more Delay Status Report MAC CEs, one or more Beam Failure Recovery MAC CEs, or any other suitable MAC CEs.

In another example, in some implementations, if a WTRU determines to monitor for second type LP-WUS, the WTRU monitors LP-WUS MOs configured for the second type of LP-WUS with periodicity P2. It is noted that the first and second type of LP-WUS signal may be the same or different, and the WTRU may be indicated by the same or different WTRU ID, WTRU subgroup ID, and/or any other suitable ID, by both types of LP-WUS. In this example, the periodicity of first and second type LP-WUS MOs is different (e.g., the periodicity P2 is shorter or longer than periodicity P1). In one example, in some implementations, periodicity P1 is a multiple of periodicity P2. In some implementations, the WTRU may determine to monitor for second type LP-WUS for a number of occasions after determining to monitor for second type LP-WUS based on transmitting and/or receiving of a specific type of data. For example, in some implementations, the WTRU monitors for second type LP-WUS for N number of second type LP-WUS MOs, where N may be a configurable parameter (it is noted that N may also be equal to 1). For example, in some implementations, the WTRU begins monitoring for second type LP-WUS after the PDCCH monitoring on first type of PDCCH MR is stopped (e.g., by an expiry of a timer).

Some implementations include monitoring of a second type LP-WUS based on an explicit indication received via a first type LP-WUS

For example, in some implementations, a WTRU may be configured to receive a primary or default LP-WUS (e.g., a first type LP-WUS) which, in addition to a wake-up signal and other WTRU-specific information, includes explicit information indicating to the WTRU to switch WUS monitoring occasions and to monitor for a secondary LP-WUS (e.g., second type LP-WUS).

In an example, in some implementations, the WTRU may initially monitor for a first type LP-WUS periodically with periodicity of P1. In some implementations, the first type LP-WUS may be expected to carry a multiple bit message (e.g., an M bit message [b₁,b₂, . . . , b_{M}]) containing one or more pieces of information. In some implementations, the information includes an indication for the WTRU to wake up and monitor for PDCCH transmissions, an ID that is specific to the WTRU, and/or a subgroup ID which identifies a subset of WTRUs to which the WTRU belongs. In some implementations, the WTRU recognizes whether the LP-WUS message is addressed to it or to another WTRU based on the group ID and/or local ID. In some implementations, in addition to an indication to wake up (e.g., when bₖ=1), the WTRU may be configured to refer to a subsequent bit (e.g., bₙ) in the sequence of bits to determine whether to proceed with monitoring for PDCCH transmissions within the resources associated with the first type LP-WUS, and/or whether the WTRU should start monitoring for a second type LP-WUS in its corresponding second type LP-WUS MOs with periodicity P2. In some implementations, the LP-WUS MOs for second type LP-WUS are more frequent than LP-WUS MOs for first type LP-WUS (i.e., P2>P1.)

In some implementations, the WTRU may receive an indication during the first type LP-WUS MO with bit-bₖ set to one (i.e. bₖ=1.) In some implementations, the WTRU is configured to refer to a subsequent bit (e.g., bit-bₙ) to determine an action to perform.

For example, in some implementations, if bit-bₙ has a first value (e.g., bₙ=0), the WTRU may proceed with monitoring for PDCCH transmissions in the monitoring resource that is associated with the first type PDCCH MR. For example, in some implementations, a WTRU receives 2 bits, bₙ and bₖ, where bₙ indicates to wake-up, and bₖ indicates what operations (e.g., monitor PDCCHs in 1^{st} type PDCCH MR, skip monitoring PDCCHs in 1^{st} type PDCCH MR and monitor 2^{nd} type LP-WUSs in 2^{nd} type LP-WUS MOs) to perform after the WTRU wakes up,

In some implementations, on the other hand, if bit-bₙ has a second value (e.g., bₙ=1), the WTRU may begin monitoring for second type LP-WUSs in second type LP-WUS MOs. In some implementations, the WTRU may begin monitoring for the second type LP-WUS starting from the next second type LP-WUS MO, and continuing for the subsequent N periods. In some implementations, the WTRU may have initially been configured with a value for N, which indicates the number of 2^{nd} type LP-WUS MOs the WTRU monitors for second type LP-WUS. Alternatively, in some implementations, the WTRU may continue to monitor for LP-WUS in the second type LP-WUS MOs until it receives an explicit indication from network.

In some implementations, if, WTRU receives a sequence of bits where bit-bₖ is set to a specific value (e.g., to zero—i.e. bₖ=0) in a first type LP-WUS received in a first type LP-WUS MO, then the WTRU will skip monitoring second type LP-WUS MOs and continue to monitor for WUS using the first type LP-WUS MOs.

In some implementations, the WTRU may be configured to receive simultaneous indications of bits bₙ and bₖ, in first type LP-WUS. In some implementations, the simultaneous indications may instruct the WTRU to wake up to monitor for PDCCH transmissions in the PDCCH MR associated with the first type LP-WUS and to initiate monitoring for LP-WUS using the second type LP-WUS MOs. In some implementations, the WTRU performs one of the following actions based on the indications in bits bₖ and bₙ, e.g., received during the first type LP-WUS in first type LP-WUS MO.

For example, in some implementations, if the WTRU receives an indication, during one of the first type LP-WUS MO, with bₖ and bₙ having first values (e.g., bₖ=1 and bₙ=1 in this example), then the WTRU will begin monitoring for PDCCH transmissions in the PDCCH MR associated with the first type LP-WUS, and will start monitoring for second type LP-WUSs using next N occurrences of second type LP-WUS MOs, for example.

In some implementations, if the WTRU receives an indication, during one of the first type LP-WUS received in first type LP-WUS MO, with bₖ and bₙ having second values (e.g., bₖ=1 and bₙ=0 in this example), then the WTRU will start monitoring for PDCCH transmissions in the PDCCH MR associated with the first type LP-WUS, but will not start monitoring for LP-WUS using the second type LP-WUS MOs.

In some implementations, if the WTRU receives an indication, during one of the first type LP-WUS received in first type LP-WUS MO, with bₖ and bₙ having third values (e.g., bₖ=0 and bₙ=1 in this example), then the WTRU will not start monitoring for PDCCH transmissions in the PDCCH MR associated with the first type LP-WUS. However, the WTRU will start monitoring for first type LP-WUSs using the next N occurrences of second type LP-WUS MOs, for example.

In some implementations, if, in the sequence of received bits during the first type LP-WUS, bₖ and bₙ have fourth values (e.g., both bits bₖ and bₙ are set to zero in this example), then the WTRU will continue to monitor for LP-WUS in the next occurrence of first type LP-WUS MO (WTRU skips monitoring LP-WUSs in next N occurrences of 2^{nd} type LP-WUS MOs).

Some implementations include monitoring of a second type LP-WUS based on a semi-static configuration

Data arrival for some WTRUs may be unpredictable. For such WTRUs, in some implementations, a gNB, base station, or other network device may not receive initial DL data in time to transmit corresponding DL scheduling PDCCHs in first PDCCH monitoring resources. As a result, the gNB, base station, or other network device may need transmit initial scheduling PDCCHs in second type PDCCH monitoring resources.

Accordingly, a WTRU may implement one or more procedures including some or all of the following.

In some implementations, a WTRU may monitor for first type LP-WUSs in first type LP-WUS MOs. For example, in some implementations, the WTRU may receive a first type LP-WUS which includes an indication (e.g., a 1-bit indication) for each WTRU or subgroup associated with the first type LP-WUS. In some implementations, the indication (e.g., 1-bit indication) for each WTRU or subgroup associated with first type LP-WUS may appear in the first type LP-WUS in an order based on a local WTRU ID or subgroup ID. Accordingly, in some implementations, based on its local UE ID or subgroup ID, the WTRU may determine the location of its corresponding 1-bit indication in the first type LP-WUS.

In some implementations, if the WTRU receives a first value (e.g., 1) for its corresponding 1-bit indication in the first type LP-WUS, the WTRU may monitor for PDCCH transmissions in next occurrences of first type PDCCH monitoring resources. In some implementations, if the WTRU receives at least one PDCCH in the next occurrence of first type PDCCH monitoring resources, the WTRU may perform one or combination of the following.

In some implementations, the WTRU may monitor for PDCCHs in up to N next occurrences of second type PDCCH monitoring resources. In some implementations, based on indications received in PDCCHs received, the WTRU may receive one or more DL signals (e.g., channel state information-reference signals (CSI-RSs), synchronization signal blocks (SSBs)) and/or channel transmissions (e.g., PDSCH, PDCCH), or may transmit one or more UL signals (e.g., SRS, PRACH) and/or channel transmissions (e.g., PUCCH, PUSCH).

In some implementations, while monitoring for PDCCH transmissions in up to N next occurrences of second type PDCH MR, if the WTRU receives an indication to skip monitoring PDCCH transmissions in remaining second type PDCCH monitoring resources, the WTRU may skip monitoring for PDCCH transmissions in second type PDCCH MR (e.g., until the next occurrence of a first type PDCCH MR.)

In some implementations, if the WTRU does not receive any PDCCH transmissions in the next occurrence of first type PDCCH MR, based on whether a corresponding parameter (e.g., “monitor-secondLPWUS”) is configured or not, the WTRU may determine to monitor for second type LP-WUS in up to N next occurrences of second type LP-WUS MOs.

For example, in some implementations, if the parameter (e.g., “monitor-secondLPWUS”) is configured, the WTRU may monitor for second type LP-WUS in up to N next occurrences of second type LP-WUS MOs. In some implementations, based on an indication received in second type LP-WUS in each second type LP-WUS MO, the WTRU may determine to monitor for PDCCH transmissions in the next occurrence of second type PDCCH monitoring resources.

In some implementations, second type LP-WUS may include an indication (e.g., 1 bit indication) for each WTRU associated with the first type LP-WUS and indications (e.g., 1-bit indications) may appear in the second type LP-WUS based on local WTRU ID or subgroup ID. In some implementations, based on its local WTRU ID or subgroup ID, the WTRU may identify its corresponding indication (e.g., 1-bit indication) in the second type LP-WUS. In some implementations, if the WTRU receives a first value (e.g., 1) for its corresponding indication (e.g., 1-bit indication) in a second type LP-WUS, the WTRU may monitor for and/or may receive a PDCCH transmission in the next occurrence of a second type PDCCH MR. In some implementations, based on on indications received in received PDCCH transmissions, the WTRU may receive one or more DL signals (e.g., CSI-RSs, SSBs, etc.) and/or channel transmissions (e.g., PDSCH, PDCCH, etc.) and/or may transmit one or more UL signals (e.g., SRS, PRACH, etc.) and/or channel transmissions (e.g., PUCCH, PUSCH, etc.). In some implementations, if the WTRU receives a second value (e.g., 0) for its corresponding indication (e.g., 1-bit indication) in the second type LP-WUS, or if the WTRU fails to receive the second LP-WUS, the WTRU may skip monitoring the next occurrence of second type PDCCH MR.

In some implementations, if the WTRU receives a second value (e.g., 0) for its or its subgroup's corresponding indication (e.g., 1-bit indication) in first type LP-WUS, the WTRU may perform one or more of the following.

In some implementations, the WTRU may skip monitoring for PDCCH transmissions in the next occurrence of first type PDCCH MR, and the next N occurrences of second type PDCCH monitoring resources. Subsequently, in some implementations, the WTRU may monitor for first type LP-WUS in the next first type LP-WUS MO. In some implementations, based on indications received in the first type LP-WUS, the WTRU may determine whether to monitor for PDCCH transmissions in the first type PDCCH MR associated with the next occurrence of first type LP-WUS MO.

In some implementations, the WTRU may skip monitoring for PDCCH transmissions in the next occurrence of first type PDCCH MR. In some implementations, if a corresponding parameter (e.g., “monitor-secondLPWUS”) is configured, the WTRU may monitor for second type LP-WUS in up to N next occurrences of second type LP-WUS MOs. In some implementations, based on an indication received in a second type LP-WUS in each second type LP-WUS MO, the WTRU may determine to monitor for PDCCH transmissions in PDCCH MR associated with each LP-WUS MR. In some implementations, based on indications received in received PDCCH transmissions in each second type PDCCH MR, the WTRU may receive one or more DL signals (e.g., CSI-RSs, SSBs, etc.) and/or channel transmissions (e.g., PDSCH, PDCCH, etc.) and/or may transmit one or more UL signals (e.g., SRS, PRACH, etc.) and/or channel transmissions (e.g., PUCCH, PUSCH, etc.)

Some implementations include follow-up behavior after WTRU wake-up for PDCCH Monitoring and/or after receiving PDCCHs.

For example, in some implementations, the WTRU wakes up its MR to monitor the first and/or second PDCCH monitoring resources. In some implementations, the WTRU is in a DRX active time after receiving a wake-up indication in a first and/or second type of LP-WUSs. In some implementations, the WTRU may perform one or more of the following actions after wakeup of the MR:

In some implementations, the WTRU may receive one or more PDCCH transmissions, e.g., in addition to the PDCCH resource associated with the wake-up indication (i.e., firs type PDCCH MR or second type PDCCH MR), by extending the active duration of the main radio. For example, in some implementations, the WTRU may extend the duration that the main radio is active (e.g., switched on) for PDCCH monitoring for a preconfigured (e.g., via RRC signaling, MAC-CE indication, DCI indication) duration based on reception of a PDCCH during first type or second type PDCCH MR.

In some implementations, the WTRU may receive one or more PDCCH transmissions associated with the DL resource assignment indicated in the received one or more PDCCH transmissions.

In some implementations, the WTRU may receive one or more other DL signals and/or signaling (e.g., CSI-RSs, SSBs, MAC CEs, etc.) within the active duration of the MR, e.g., based on the configured resources for the corresponding receptions (e.g., a resource or resources configured within the active duration of first or second PDCCH monitoring.)

In some implementations, the WTRU may perform transmissions of selected signals and/or information (e.g., CSI report, SRS, SR, PUCCH, etc.). For example, in some implementations, if the WTRU is configured to perform preconfigured (e.g., via RRC signaling, MAC-CE indication, DCI indication) (e.g., periodic) transmissions (e.g., CSI reports), and/or if the WTRU did not perform preconfigured (e.g., CSI report)transmission for at least a given duration (e.g., based on a timer), the WTRU may use the active duration to perform the UL transmissions.

For example, in some implementations, the WTRU may receive a configuration or pre-configuration indicating that some transmissions are associated within a first type of PDCCH monitoring active duration while some other transmissions are associated within a second type of PDCCH monitoring active duration.

In some implementations, the WTRU may receive the configuration that CSI reports and SRS may be transmitted in the first type of PDCCH monitoring active duration while SRS and SR transmissions may be transmitted in the second type of PDCCH monitoring active duration.

In another example, in some implementations, the WTRU may receive a configuration or pre-configuration indicating that the transmissions are associated with a delay, timer, and/or offset from the PDCCH MR. In some implementations, the delay, timer, and/or offset may be transmission specific and/or PDCCH resource monitoring type-specific.

For example, in some implementations, a first delay, timer, and/or offset may be set between a first type PDCCH MR (e.g., starting symbol of first type PDCCH MR) and an SRS transmission time, and a second delay, timer, and/or offset may be set between a second type of PDCCH MR (e.g., starting symbol of second type PDCCH MR) and an SRS transmission time.

In another example, in some implementations, a third delay, timer, and/or offset may be set between a first type PDCCH MR and a CSI report transmission time, and a fourth delay, timer, and/or offset may be set between a second type of PDCCH MR and an CSI report transmission time.

In some implementations, the WTRU may perform additional actions based on having received a PDCCH transmission in the first and/or second type PDCCH MR. In some implementations, the actions may be specific or may have a specific configuration for whether they are performed after reception of a PDCCH transmission in the first or in the second type of PDCCH MR. For example, in some implementations, the WTRU may perform one or more of the following.

In some implementations, if the WTRU receives a configuration or pre-configuration of a first timer associated with a first type of PDCCH monitoring resource, and a second timer associated with a second type of PDCCH monitoring resource, the timers may have different durations.

In some implementations, based on reception of a PDCCH transmission in a first type of PDCCH MR, the WTRU may start the first timer (e.g., an inactivity timer) to extend the first PDCCH monitoring duration.

In some implementations, based on reception of a PDCCH transmission in a second type of PDCCH MR, the WTRU may start the second timer (e.g., an inactivity timer) to extend the second PDCCH monitoring duration.

In some implementations, the WTRU may have received a configuration or pre-configuration of an association between the reception of a PDCCH transmission in the first and/or second type PDCCH MR and the reception of a DL signal and/or indication (e.g., CSI-RS, SSB, MAC-CE, additional PDCCH, PDSCH, etc.)

For example, in some implementations, the WTRU may have received a configuration or pre-configuration to monitor and/or receive a configured or preconfigured CSI-RS when receiving a PDCCH transmission in the first PDCCH MR, and another CSI-RS when receiving a PDCCH in the second PDCCH MR.

In another example, in some implementations, the WTRU may have received a configuration or pre-configuration to monitor and/or receive a configured or preconfigured MAC CE indication in resources associated with the first PDCCH monitoring resource when receiving a PDCCH in the first PDCCH monitoring resource, and another MAC CE indication when receiving a PDCCH in the second PDCCH monitoring resource.

In another example, in some implementations, the WTRU may have received a configuration or pre-configuration to monitor for a PDCCH transmission in configured or preconfigured resources associated with the first PDCCH MR when receiving a PDCCH in the first PDCCH MR, and another configuration to monitor for a PDCCH transmission in another configured or preconfigured resource associated with the second PDCCH MR when receiving a PDCCH in the second PDCCH MR.

In some implementations, the WTRU may perform transmissions of one or more preconfigured (e.g., via RRC signaling, MAC-CE indication, DCI indication) signals (e.g., SRS) and/or channels (e.g., PUCCH carrying SR, CSI reports, HARQ feedback, PUSCH SR, CSI reports, HARQ feedback) based on the reception of a PDCCH transmission in the first and/or second type PDCCH MR. For example, in some implementations, if the WTRU is configured to perform preconfigured (e.g., via RRC signaling, MAC-CE indication, DCI indication) transmissions (e.g., periodic CSI reports), and/or if the WTRU did not perform a preconfigured (via RRC signaling, MAC-CE indication, DCI indication) type of transmission for at least a given duration (e.g., based on a timer), and/or if the WTRU performs a transmission triggered by the reception of the PDCCH or the associated PDSCH (e.g., HARQ feedback) the WTRU may use the active duration to perform the UL transmissions.

For example, in some implementations, the WTRU may receive a configuration or pre-configuration indicating that the transmissions are associated with a delay, timer, and/or offset from the reception of the PDCCH transmission. In some implementations, the delay, timer, and/or offset may be transmission specific and/or PDCCH resource monitoring type-specific.

For example, in some implementations, a first delay, timer, and/or offset may be set between the reception of a PDCCH transmission in a first type PDCCH MR and an SRS transmission time, and a second delay, timer, and/or offset may be set between the reception of a PDCCH transmission of a second type of PDCCH MR and an SRS transmission time.

In another example, in some implementations, a third delay, timer, and/or offset may be set between the reception of a PDCCH transmission in a first type PDCCH MR and a CSI report transmission time, and a fourth delay, timer, and/or offset may be set between the reception of a PDCCH transmission of a second type of PDCCH MR and a CSI report transmission time.

In another example, in some implementations, another delay, timer, and/or offset may be set between the reception of a PDCCH transmission of a first type PDCCH MR and a HARQ feedback transmission time, and another delay, timer, and/or offset may be set between the reception of a PDCCH transmission of a second type of PDCCH MR and an HARQ feedback transmission time.

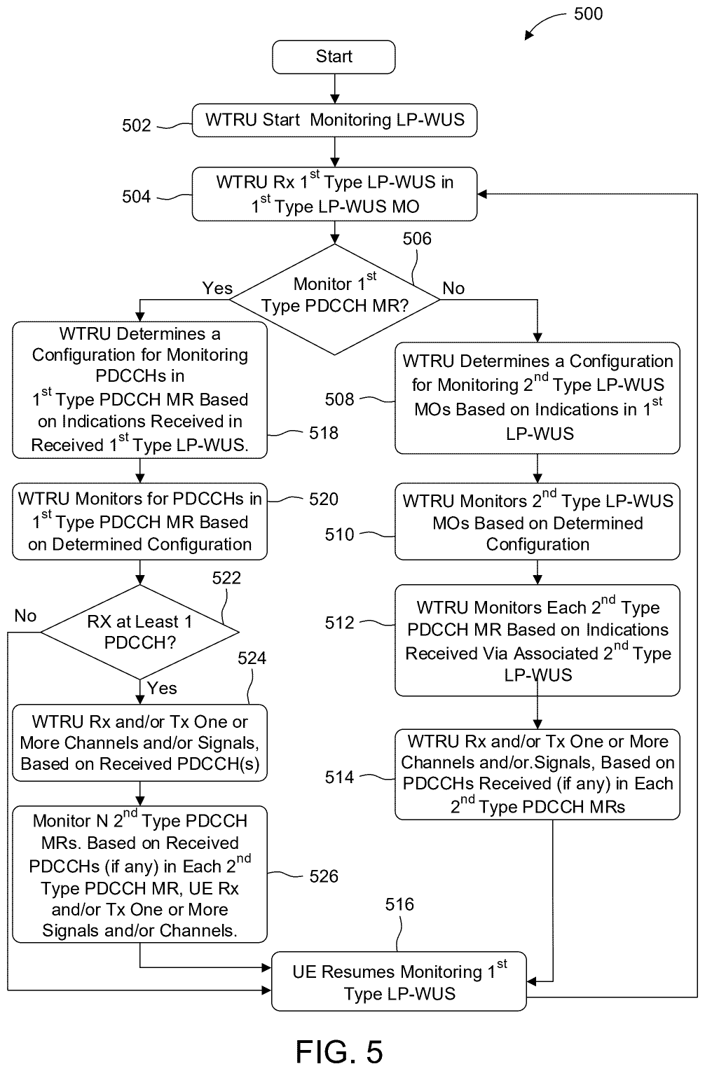

FIG. 5 is a flow chart illustrating an example procedure 500 for configuration of PDCCH monitoring resources and LP-WUS MOs.

In some implementations, based on indications received in a first type LP-WUS, a WTRU determines one or more of, whether to monitor for PDCCH transmissions in a first type PDCCH MR, a configuration for monitoring PDCCH transmissions in first type PDCCH MR, and/or a configuration for monitoring for second type LP-WUSs in second type LP-WUS MOs. In some implementations, based on indications received in first and second type LP-WUSs collectively (e.g., based on indications received in first type LP-WUS and second type LP-WUS), the WTRU determines whether to monitor for PDCCH transmissions in a second type PDCCH MR.

Prior to procedure 500, the WTRU receives configuration information from a gNB, base station, or other network device.

For example, in some implementations, the WTRU receives configuration information indicating first and second type PDCCH MRs. In some implementations, the first type PDCCH MRs are periodic with period T. In some implementations, the configuration information indicates the period T. In some implementations, each PDCCH MR is or includes a set of time-frequency resources. In some implementations, a set of N (≥1) second type PDCCH MRs are associated with each first type PDCCH MR. In some implementations, the second type PDCCH MRs are equally spaced in time, and in some implementations, this is indicated by the configuration information. In some implementations, all N second type MRs in a set are located within a time window (W) from an associated first type PDCCH MR, and in some implementations, this is indicated by the configuration information. In some implementations, W<T (e.g., as shown and described with respect to FIG. 4.

In some implementations, the WTRU receives configuration information indicating first and second type LP-WUS MOs associated with first and second type PDCCH MRs, respectively. For example, in some implementations, the configuration information indicates that each type of LP-WUS MO is located with an offset from associated PDCCH MR.

In some implementations, the WTRU receives configuration information indicating two types of LP-WUS. In some implementations the configuration information indicates first and second type LP-WUSs associated with first and second type LP-WUS MOs, respectively. In some implementations, the configuration information indicates a structure of the first and second type LP-WUSs and/or a structure of a payload of the first and second type LP-WUSs is configured or preconfigured to both gNB (or other network device) and the WTRU.

In some implementations, the WTRU receives configuration information indicating two configurations for PDCCH monitoring in first type PDCCH MRs. For example, in some implementations, the configuration indication indicates whether the first type PDCCH MRs occur with or without an offset. In some implementations, the WTRU receives configuration information indicating two configurations for monitoring second type LP-WUS MOs. For example, in some implementations, the configuration indication indicates either sparse monitoring of second type LP-WUS MOs, or monitoring of every (e.g., within a set) second type LP-WUS MOs.

In some implementations, the WTRU receives configuration information for monitoring LP-WUS.

The WTRU monitors for a first type LP-WUS At 502, and receives first type LP-WUS in a first type LP-WUS MO at 504.

In some implementations, e.g., based on indications received in first type LP-WUS, the WTRU determines whether to monitor for PDCCH transmissions in one or more first type PDCCH MRs, determines a configuration for PDCCH monitoring in one or more first type PDCCH MRs, and/or a configuration for monitoring second type LP-WUS MOs.

In an example configuration, in some implementations, first type LP-WUSs include 2 fields (e.g., x, and y, which may each be 1-bit in length) corresponding to each WTRU associated with a LP-WUS MO or each subgroup of WTRUs associated with a LP-WUS MO. In some implementations, the first field (x-bit in this example) indicates (a) a configuration of the WTRU to monitor PDCCHs in first type PDCCH MRs or (b) a configuration of the WTRU to monitor second type LP-WUS MOs.

In some implementations, the second field (y-bit in this example) indicates whether the x-bit is associated with (a) or (b). For example, in some implementations, y=1 for option (a) and y=0 for option (b)).

Accordingly, in this example, on condition 506 that y=1 in the received first type LP-WUS, the WTRU skips monitoring for PDCCHs in next first type PDCCH MR and determines a configuration for monitoring second type LP-WUS MOs based on the indications in the first type LP-WUS at 508. At 510, the WTRU monitors for and receives second type LP-WUSs in up to N next second type LP-WUS MOs. In some implementations, the WTRU determines a configuration for monitoring the second type LP-WUS MOs based on the first field (x-bit in this example) in first type LP-WUSs. For example, if x=0, the WTRU monitors second type LP-WUS MOs sparsely (e.g., WTRU skips monitoring every other second-type LP-WUS MO, or every third second-type LP-WUS MO, etc.), and if x=1, the WTRU monitors all second type LP-WUS MOs.

At 512, if the WTRU receives a first indication in a second LP-WUS received in a second type LP-WUS MO, the WTRU monitors for PDCCHs in the next second type PDCCH MR. If UE receives second indication, UE skips the next second type PDCCH MR and monitors next second type LP-WUS MO.

At 514, the WTRU receives one or more signals (e.g., CSI-RS, SSB) and/or channels (PDSCH, PDCCH) and/or transmits one or more signals (e.g., SRS) and/or channels (PUCCH, PUSCH) based on indications received in second type PDCCH transmissions via second type PDCCH MRs, if any were received at 512.

At 516, the WTRU resumes monitoring for first type LP-WUS, and the flow returns to 504.

On condition 506 that the WTRU receives y=0 in the received first type LP-WUS, the WTRU monitors for PDCCHs in next first type PDCCH MRs, and determines a configuration for monitoring PDCCHs in next first type LP-WUS MR based on first field (x-bit) of first type LP-WUS at 518. For example, if x=0, the WTRU begins monitoring for PDCCHs at an offset at 520, and if x=1, the WTRU begins monitoring for PDCCHs without an offset at 520.

On condition 522 that the WTRU receives at least one PDCCH in a first type PDCCH MR, the WTRU receives one or more signals (e.g., CSI-RS, SSB) and/or channels (PDSCH, PDCCH) and/or transits one or more signals (e.g., SRS) and/or channels (PUCCH, PUSCH) based on the received first type PDCCH transmission at 524, and also monitors for PDCCHs in N next occurrences of second PDCCH MRs. At 526, the WTRU receives one or more signals (e.g., CSI-RS, SSB) and/or channels (PDSCH, PDCCH) and/or transits one or more signals (e.g., SRS) and/or channels (PUCCH, PUSCH) based on any received second type PDCCH transmissions. At 516, the WTRU resumes monitoring for first type LP-WUS, and the flow returns to 504. Otherwise, on condition 522 that the WTRU does not receive at least one PDCCH in a first type PDCCH MR, the WTRU resumes monitoring for first type LP-WUS at 516, and the flow returns to 504.

In some implementations, procedure 500 may have the advantage of reducing power consumption and/or reducing latency of the WTRU.

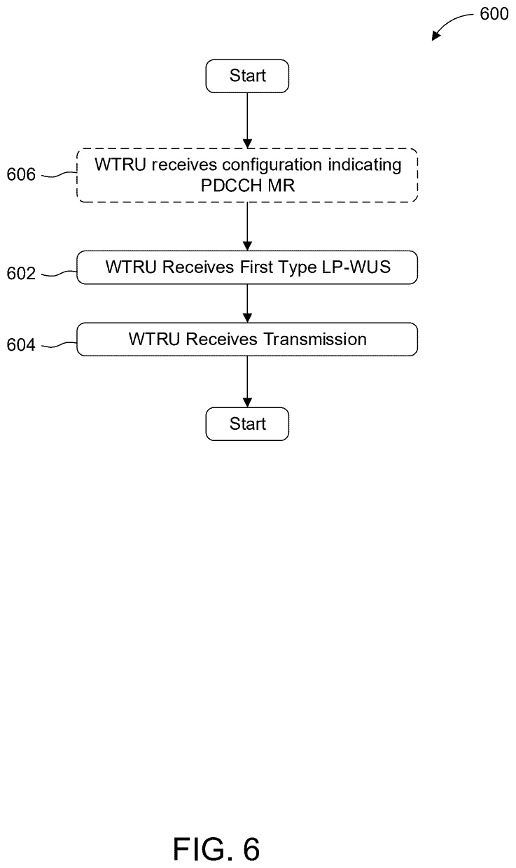

FIG. 6 is a flow chart illustrating an example procedure 600 for configuration of PDCCH monitoring resources and LP-WUS MOs. In some implementations, procedure 600 is implemented in a WTRU (e.g., as shown and described with respect to FIGS. 1A, 1B, 1C, and 1D, and any devices, systems, or procedures discussed herein.

At 602, the WTRU receives a first type LP-WUS in a first type LP-WUS MO. In some implementations, the first type LP-WUS includes a first indication and a second indication.

At 604, the WTRU receives a transmission based on the first indication and the second indication. In some implementations, the receiving includes receiving a second type LP-WUS based on the first indication having a first value. In some implementations, the receiving includes receiving a PDCCH transmission based on the first indication having a second value.

In some implementations, the receiving comprises receiving the second type LP-WUS on one of a plurality of sparsely monitored second type LP-WUS MOs sparsely, based on the first indication having the first value and the second indication having the first value. In some implementations, the receiving comprises receiving the second type LP-WUS one of a plurality of second type LP-WUS MOs, based on the first indication having the first value and the second indication having the second value. In some implementations, the receiving comprises receiving a next PDCCH transmission at an offset, based on the first indication having the second value and the second indication having the first value. In some implementations, the receiving comprises receiving a next PDCCH transmission without an offset, based on the first indication having the second value and the second indication having the second value.

At 606, in some implementations, the WTRU receives configuration information indicating first and second type PDCCH monitoring resources (PDCCH MR). In some implementations, the WTRU receives the first type LP-WUS on a low-power receiver, and receives the PDCCH transmission on a main receiver.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented in a wireless transmit/receive unit (WTRU), the method comprising:
receiving a first type low-power wakeup signal (LP-WUS) during a first type LP-WUS monitoring occasion (MO), the first type LP-WUS including a first indication and a second indication; and
receiving a transmission, based on the first indication and the second indication,
wherein the receiving comprises receiving a second type LP-WUS based on the first indication having a first value, and
wherein the receiving comprises receiving a PDCCH transmission based on the first indication having a second value.

2. The method of claim 1, wherein the receiving comprises receiving the second type LP-WUS on one of a plurality of sparsely monitored second type LP-WUS MOs sparsely, based on the first indication having the first value and the second indication having the first value.

3. The method of claim 1, wherein the receiving comprises receiving the second type LP-WUS on one of a plurality of second type LP-WUS MOs, based on the first indication having the first value and the second indication having the second value.

4. The method of claim 1, wherein the receiving comprises receiving a next PDCCH transmission at an offset, based on the first indication having the second value and the second indication having the first value.

5. The method of claim 1, wherein the receiving comprises receiving a next PDCCH transmission without an offset, based on the first indication having the second value and the second indication having the second value.

6. The method of claim 1, further comprising receiving configuration information indicating first and second type PDCCH monitoring resources (MRs).

7. The method of claim 1, further comprising receiving configuration information indicating first and second type LP-WUS MOs.

8. A method implemented in a wireless transmit/receive unit (WTRU), the method comprising:
receiving a first type low-power wakeup signal (LP-WUS) during a first type LP-WUS monitoring occasion (MO), the first type LP-WUS including a first indication and a second indication; and
monitoring for a transmission, based on the first indication and the second indication,
wherein the monitoring comprises skipping monitoring for a physical downlink control channel (PDCCH) transmission and receiving a second type LP-WUS based on the first indication having a first value, and
wherein the monitoring comprises monitoring for a PDCCH transmission based on the first indication having a second value.

9. The method of claim 8, wherein the monitoring comprises monitoring second type LP-WUS MOs sparsely, based on the first indication having the first value and the second indication having the first value.

10. The method of claim 8, wherein the monitoring comprises monitoring all second type LP-WUS MOs, based on the first indication having the first value and the second indication having the second value.

11. The method of claim 8, wherein the monitoring comprises monitoring for a next PDCCH transmission at an offset, based on the first indication having the second value and the second indication having the first value.

12. The method of claim 8, wherein the monitoring comprises monitoring for a next PDCCH transmission without an offset, based on the first indication having the second value and the second indication having the second value.

13. The method of claim 8, further comprising receiving configuration information indicating first and second type PDCCH monitoring resources (MRs).

14. The method of claim 8, further comprising receiving configuration information indicating first and second type LP-WUS MOs.

15. A wireless transmit/receive unit (WTRU) comprising:
circuitry configured to receive a first type low-power wakeup signal (LP-WUS) during a first type LP-WUS monitoring occasion (MO), the first type LP-WUS including a first indication and a second indication; and
circuitry configured to monitor for a transmission, based on the first indication and the second indication,
wherein the monitoring comprises skipping monitoring for a physical downlink control channel (PDCCH) transmission and receiving a second type LP-WUS based on the first indication having a first value, and
wherein the monitoring comprises monitoring for a PDCCH transmission based on the first indication having a second value.

16. The WTRU of claim 15, wherein the monitoring comprises monitoring second type LP-WUS MOs sparsely, based on the first indication having the first value and the second indication having the first value.

17. The WTRU of claim 15, wherein the monitoring comprises monitoring all second type LP-WUS MOs, based on the first indication having the first value and the second indication having the second value.

18. The WTRU of claim 15, wherein the monitoring comprises monitoring for a next PDCCH transmission at an offset, based on the first indication having the second value and the second indication having the first value.

19. The WTRU of claim 15, wherein the monitoring comprises monitoring for a next PDCCH transmission without an offset, based on the first indication having the second value and the second indication having the second value.

20. The WTRU of claim 15, further comprising circuitry configured to receive configuration information indicating first and second type PDCCH monitoring resources (MRs).
